(19) United States
(12) Patent Application Publication
(10) Pub. No.: US 2003/0101261 A1
(43) Pub. Date: May 29, 2003

(54) Failure analysis support system

(75) Inventors: Hirokazu Ikeda, Sagamihara (JP); Masaharu Akatsu, Machida (JP)

Correspondence Address: Steve Y. Cho, Townsend and Townsend and Crew LLP, Two Embarcadero Center, 8th Floor, San Francisco, CA, 94111, US

(73) Assignee: Hitachi, Ltd., Tokyo (JP)

(21) Appl. No.: 10/302,102

(22) Filed: Nov. 21, 2002

(30) Foreign Application Priority Data
Nov. 26, 2001 (JP) 2001-358665

(51) Int. Cl. G06F 15/173

(52) U.S. Cl. 709/224; 713/201; 340/506

(57) ABSTRACT

A network management system for managing a network system includes a first data storage device configured to store operation information of a plurality of components of the network system. The operation information provides information about operating states of the components. A display device is configured to provide a temporal tool displaying a plurality of points of time and a component display area to display a plurality of first indications representing the components and a plurality of second indications representing operating states of the components. The pluralities of the first and second indications correspond to one of the points of time selected on the temporal tool. A data processor is configured to process the operation information and transmit data to the display device to display the first and second indications on the display area of the display device.

### CROSS-REFERENCES TO RELATED APPLICATIONS

The present application is related to and claims priority from Japanese Patent Application No. 2001-358665, filed on Nov. 26, 2001.

### BACKGROUND OF THE INVENTION

In general, the present invention relates to an operation management technology for a network system.

In a conventional operation monitoring or fault analysis system, a technique for determining an operating state of a system is provided by displaying the present operating states of a plurality of monitored components in a network system. The past operating states are stored as a log file for backup purposes. If desired, the past operating states for each component may be viewed as a graph. The operating states of system components, e.g., a server, CPU, software, and memory, are provided by retrieving operation information or metrics from the system components. The operation information or metric is generated by processing Management Information Bases (MIBs) collected from the system components using the Simplified Network Management Protocol (SNMP). As used herein, the term “operation information” or “metric” refers to data that provides information about an operating state of a system component. These two terms are used interchangeably herein and may also be used to refer to the MIB for ease of illustration.

Japanese Patent Laid-open No. 2000-40021, entitled “Monitoring & Display System and Recording Medium” describes a method of simplifying a failure analysis by displaying the present operating states of the monitored components in a matrix of the primary components (e.g., a server) and the secondary components therein (e.g., CPU and memory).

In order to analyze a fault, a conventional technique stores metrics or operation information in a database or a file periodically or sequentially. In addition, in order to treat the pieces of operation information in a collective manner, a technique is provided wherein the operation information is stored in a storage area in a uniform format. Japanese Patent Laid-open No. Hei 6-331381, entitled “Measurement & Display Method,” discloses a technology of obtaining an average of metric values and storing the average value for use in a subsequent failure analysis in order to use less storage space.

### BRIEF SUMMARY OF THE INVENTION

In order to determine the cause of a fault or failure in a network system, it is useful to know both the present and past states of the system components. With the conventional technique, although the operating state for present values can be determined relatively easily, it is difficult to easily compare the past states with the present operating state. In addition, the conventional methods do not enable seamless display of the changes to the operating states of system components over time.

Furthermore, the past operation information used in a failure analysis should include information collected at a fine time granularity and a coarse time granularity, at which an averaging process is carried out in order to determine changes in the operating states of the system components at a macro level over a period of time. Traditionally, operation information has been stored at a given time granularity without regard to its usefulness, e.g., older information is generally less useful than more recent information. Generally, operation information is obtained at a fine time granularity since it may be converted to operation information corresponding to a coarse time granularity. This, however, requires a large data storage to store the fine operation information over time. As used herein, the term “fine operation information” or “fine metric” refers to operation information or metric that is associated with a fine time granularity. Similarly, the term “coarse operation information” or “coarse metric” refers to operation information or metric that is associated with a coarse time granularity.

One embodiment of the present invention relates to a method for determining a cause of a fault or alert, wherein the operating states of the components at various different points of time may be displayed seamlessly. The operation information to be used in a failure analysis is stored at a time granularity according to its usefulness. The temporal operating states of the system components can be displayed seamlessly, e.g., by making a selection on a temporal tool displayed on the display area.

In one embodiment, a network management system for managing a network system includes a first data storage device configured to store operation information of a plurality of components of the network system, the operation information providing information about operating states of the components; a display device configured to provide a temporal tool displaying a plurality of points of time and a component display area to display a plurality of first indications representing the components and a plurality of second indications representing operating states of the components, wherein the plurality of the first and second indications correspond to one of the points of time selected on the temporal tool; and a data processor configured to process the operation information and transmit data to the display device to display the first and second indications on the display area of the display device.

The system also includes a second data storage device including computer readable code to enable the data processor to process the operation information, the second data storage device including: code for providing the temporal tool on display device, code for providing the display area on the display device, and code for retrieving operation information corresponding to the selected point of time from the first data storage device for displaying the first and second indications on the display device.

In another embodiment, a method of managing a network system including a plurality of components includes providing a temporal tool on a display device, the tool including a plurality of points of time; and displaying information about first operating states of the components on the display device in response to a first point of time selected on the temporal tool, the first operating states representing operating states of the components at the first point of time.

In another embodiment, a method of managing a storage area network (SAN) system includes storing in a storage device first operation information providing information about operating states of a plurality of components of the SAN system, the first operation information being stored at a first time granularity; providing a timeline tool on a display device, the tool including a plurality of points of time, each point of time representing a time interval; displaying information about first operating states of the components on the display device in response to selection of a first point of time on the tool, the first operating states representing operating states of the components at the first point of time; displaying information about second operating states of the components on the display device in response to selection of a second point of time on the tool, the second operating states representing operating states of the components at the second point of time, thereby providing seamless display of operating states of the components over the plurality of the points of time; and converting the first operation information to second operation information of a second time granularity at a later time after the storing step, the second operation information providing more coarse information than the first operation information.

In another embodiment, a method of managing a messaging network system includes storing in a storage device first operation information providing information about operating states of a plurality of components of the network system, the first operation information being stored at a first time granularity; providing a timeline tool on a display device, the tool including a plurality of points of time, each point of time representing a time; displaying information about first operating states of the components on the display device in response to selection of a first point of time on the tool, the first operating states representing operating states of the components at the first point of time; displaying information about second operating states of the components on the display device in response to selection of a second point of time on the tool, the second operating states representing operating states of the components at the second point of time, thereby providing seamless display of operating states of the components over the plurality of the points of time; converting the first operation information to second operation information of a second time granularity at a later time after the storing step, the second operation information providing more coarse information than the first operation information; and associating priority information to selected first operation information to prevent its conversion to the second operation information, wherein the selected first operation information provides information about an irregular operating state of one of the components.

In yet another embodiment, a computer readable medium including a software program for managing a network system includes code for providing a temporal tool on a display device, the tool including a plurality of points of time; and code for displaying information about first operating states of the components on the display device in response to a first point of time selected on the temporal tool, the first operating states representing operating states of the components at the first point of time.

### BRIEF DESCRIPTION OF THE DRAWINGS

FIG. 1A shows a network system including a failure-analysis management system according to one embodiment of the present invention.

FIG. 1B shows a network system including a failure-analysis management system according to another embodiment of the present invention.

FIG. 1C is a diagram showing a display area of a network management system for displaying system components and their operating states.

FIG. 2 shows a temporal tool of a network management system according to one embodiment of the present invention.

FIG. 3 shows temporal graphs denoting the operating states of selected components according to one embodiment of the present invention.

FIG. 4 is a block diagram showing a configuration of a network management system according to one embodiment of the present invention.

FIG. 5 shows data stored in an operation-information storage device of a network management system according to one embodiment of the present invention.

FIG. 6 shows a logical configuration of a definition-information storage device employed in a network management system according to one embodiment of the present invention.

FIG. 7 shows data format of information stored in a definition-information storage device of a network management device according to one embodiment of the present invention.

FIG. 8 is a flowchart representing processing carried out by an operation-information-processing unit of a network management system according to one embodiment of the present invention.

FIG. 9 shows a process involved in storing operation information of a component that has experienced a fault according to one embodiment of the present invention.

FIG. 10 shows a display area of a network management system, including an operating state display portion, a metric list view, and a temporal tool according to one embodiment of the present invention.

### DETAILED DESCRIPTION OF THE INVENTION

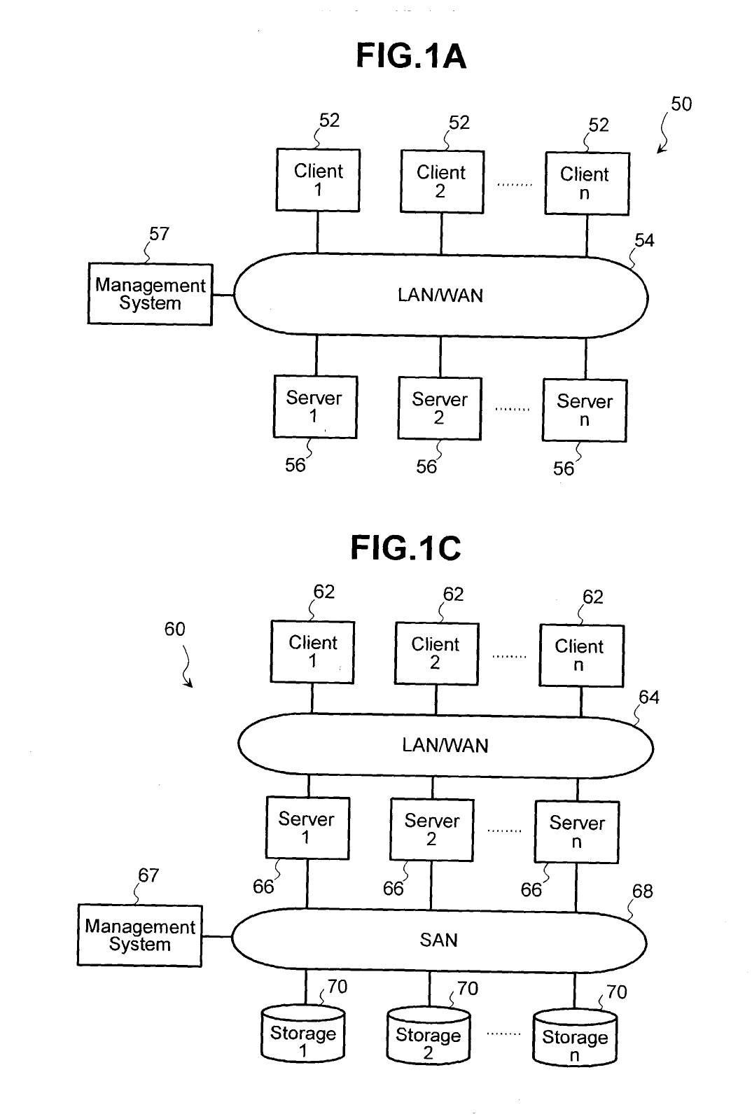

FIGS. 1 to 10 depict a network management system, e.g., a failure analysis management system, and related processes and displays according to embodiments of the present invention. Substantially identical components are generally denoted by the same reference numerals. FIGS. 1A and 1B illustrate exemplary networks wherein a network management system of the present embodiment may be implemented. In one embodiment, a messaging network system 50 includes a plurality of client systems 52, a messaging network 54, a plurality of servers 56, and a network management system or failure-analysis management system 57 (FIG. 1A). The clients 52 are coupled to the servers 56 by the messaging network 54. The network 54 may be a local area network or a wide area network, or a combination thereof. The management system 57 monitors the operating states of the clients, servers, and network (“primary components”), as well as hardware and software associated with these devices (“secondary components”), for any failure or caution alerts in order to assist a network administrator in managing the network system. These monitored objects are referred to herein as “components” or “system components.”

Referring to FIG. 1B, a network system 60 includes a plurality of clients 62, a messaging network 64, a plurality of servers 66, a storage network 68, a plurality of storage areas, and a management system 67. The storage network 68 is a storage area network (SAN) in one embodiment of the present invention. The SAN supports direct high-speed data transfers between the servers 66 and storage devices 70 in various different ways; e.g., data may be transferred between a server and a storage device, or between the servers, or between the storage devices. The management system 67 may monitor only the SAN 68, or monitor the servers 66, the SAN 68, and the storage devices 70, or monitor the entire network system 60. Alternatively, two or more management systems may be used to monitor the components of the network.

FIG. 1C shows a display device including a display area 15 of a failure-analysis system according to one embodiment of the present invention. As used herein, the terms “display device” and “display area” are used interchangeably for purposes of illustration. The display area 15 comprises an operating state display portion 10 (also referred to as a “component display area”) showing the system components being monitored including their operating states and a temporal tool 20 for retrieving operation information corresponding to a particular point of time and displaying the operating states on the display portion 10. In one embodiment, the temporal tool includes a timeline bar 22 representing a timeline and a time selector 30, e.g., a cursor or pointer, for selecting a point of time on the timeline. Alternatively, the temporal tool 20 may include a plurality of blocks or discrete marks representing a plurality of points of time, so that one of these may be selected using the selector 30. In one embodiment, the temporal tool 20 is provided on a touch pad screen, so that a time selector may or may not be used.

The display portion 10 displays a plurality of system components 12. The displayed components 12 include a network node represented by an IP address, a program to be executed, and a function preformed by a program. Operation information of each component 12 is collected at a given time interval or time granularity to display the operating states of the components. In one embodiment, various operating states are represented by color-coding the components. For example, a component with a blue color indicates a normal state, an orange color indicates a caution state, and a red color indicates a danger state. In another embodiment, the information relating to the attributes of the components 12 including its type and operating state are conveyed using selected icons or symbols, colors, sizes, blinking frequencies, and the like. For example, a fault icon 11 indicates that a failure has occurred at the identified location.

Using the temporal tool 20, a network administrator may conveniently view the operating states of the components 12 as they change over a period of time. In addition, if fault or failure occurs at a plurality of locations in the network system, it is generally difficult to separate the causes from each other. However, depending on the fault types, the distribution of the fault locations and the temporal changes of the operating states exhibit a specific pattern. The method and system described herein provides an efficient way of keeping track of the distribution of the fault locations and changes in the operating states over a period of time for efficient fault analysis.

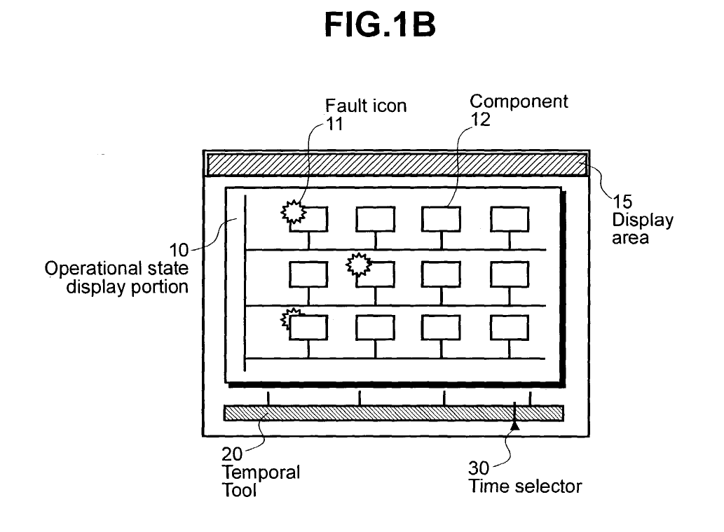

FIG. 2 shows the temporal tool 20 including a plurality of timeline bars 21, 22, and 23 according to one embodiment of the present invention. That is, the timeline bar 20 includes a fault frequency bar 21, a minimum time granularity bar 22, and an adjustment event or generation change bar 23.

The fault or failure frequency bar 21 displays the frequency at which components fail along a timeline represented by the bar. In the embodiment shown in FIG. 2, the frequency of failure is denoted by different colors, e.g., the darkness of the color corresponds to the frequency of failure. The frequency of failure refers to a number of failures in the network for a given time period. By referring to the failure frequency bar 21, a network administrator may identify a time zone in which a main failure has occurred in the past and quickly determine the operating states before and after that time period.

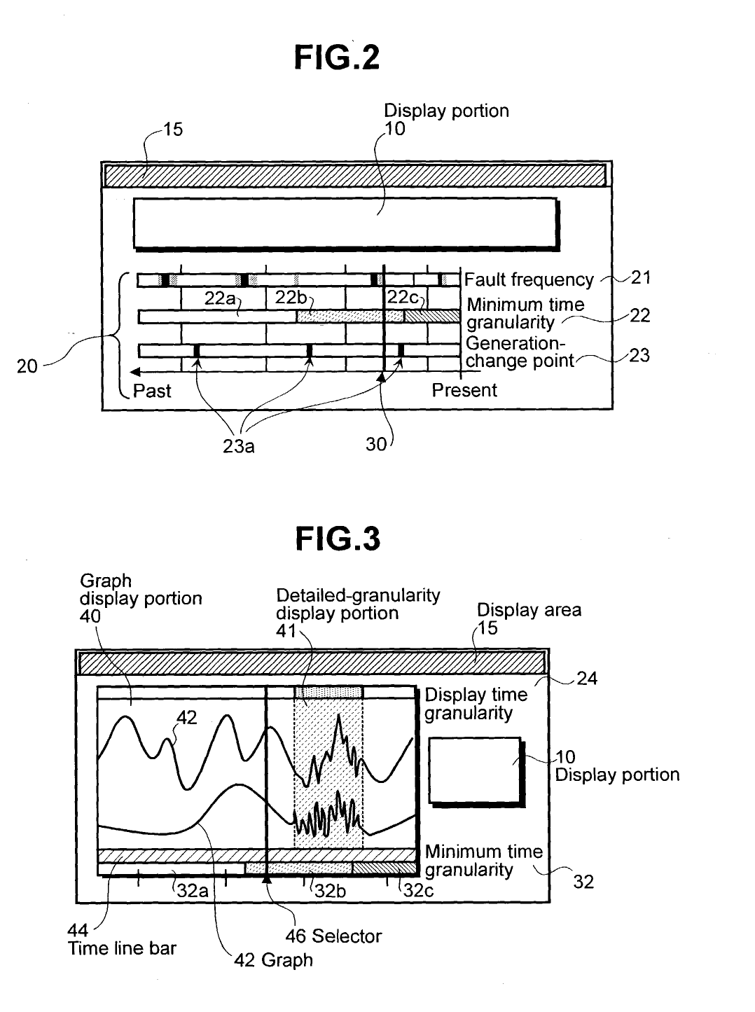

The minimum time granularity bar 22 displays the smallest time unit that is used in processing the data for display in the display portion 10 (or a timeline graph display portion 41 in FIG. 3). In the embodiment shown in FIG. 2, the concentration becomes higher along the timeline in proportion to the fineness of the time granularity that can be used in processing the data for display on the display portion 10. The bar 22 includes a coarse time portion 22a, a medium time portion 22b, and a fine time portion 22c. The minimum time granularity 22 is not necessarily a time granularity used actually in a display, but a granularity at which data can be displayed, as will be explained by referring to FIG. 3.

The generation-change point bar 23 provides information about when an adjustment event or a change of a kind has been made for a component. Marks 23a on the timeline indicate the occurrence of adjustment events at those points of time. The term “adjustment event” or “change of a kind” refers to an event that affects the operation of a component, such as a hardware or software change. Examples of hardware changes are a CPU replacement, addition of a memory, and replacement of a hard disc. Examples of software changes are an installation of an upgraded version and parameter changes. The fault frequency bar 21 and the adjustment event bar 23 may be used together to determine if there is any correspondence between the two.

FIG. 3 is a diagram showing a plurality of graphs 42 displayed on the graph display portion 40 for use in a failure analysis according to one embodiment of the present invention. Each graph provides information about the operating state of a component. The graph is displayed by selecting a point in the timeline and a component of interest. In response, corresponding temporal operation information of the selected component is retrieved. The operation information corresponding to immediately preceding and succeeding the selected time is also retrieved. A graph is then generated using the retrieved operation information and displayed on the display portion 40. As shown in FIG. 3, a plurality of components may be selected to display a plurality of graphs on the display portion 40.

In the present embodiment, the graph display portion 40 is displayed in the display area 15 together with the operating state display portion 10. In another embodiment, the display portion 40 may replace the display portion 10 in order to provide an enlarged view.

A timeline bar 44, similar to the temporal tool 20, is provided along a horizontal axis of the graph display portion 40. A selector 46 indicates the selected time for which the graph is being displayed. The selector 46 may be used to select other points of time along the timeline bar 44 to view the corresponding graphs. This operation is performed similar to that described in connection with the operating state display portion 10 and the temporal tool 20 in FIG. 1C.

A minimum time granularity bar 32, corresponding to the bar 22 in FIG. 2, indicates the smallest unit of time at which information can be displayed on the display portion 40. A time granularity or unit of time refers to an interval at which operation information is stored. In one embodiment, the operation information is collected and stored every 30 seconds. The stored value could be an average value or an actual value at that instant. The operation information collected at every 30 seconds may be stored directly or may be averaged over a period longer than 30 seconds before storing. For example, the operation information collected every 30 seconds over a period of 5 minutes is averaged, and then stored. This time period may be 2 minutes, 5 minutes, 30 minutes, 1 hour, 3 hours, and the like. Accordingly, the fineness of operation information may be adjusted according to the needs of a network administration.

The minimum time granularity bar 32 indicates the fineness or resolution of the operation information used to generate the corresponding portions of the graphs 42. The bar 32 shows a coarse granularity portion 32a, a medium granularity portion 32b, and a fine granularity portion 32c. The operation information stored in these time periods, have different minimum time granularities. In the coarse portion 32a, the minimum time granularity is one hour so the stored operation information represents the operating state of a component for a given hour. The medium portion 32b and the fine portion 32c have the minimum time granularities of 5 minutes and 30 seconds, respectively. Accordingly, the operating states corresponding to the fine portion can be displayed on the display portion 40 with the greatest detail, then that of the medium portion 32b, and then that of the coarse portion. If desired, statistical processing may be performed on the operation information to view the operating state of a component using a larger time granularity than it minimum time granularity. For example, the operation information for a fine portion may be processed to display the operating states at intervals of greater than 30 seconds, e.g., 5 minutes or 1 hour.

For a given graph, in order to display it at a uniform time granularity, it is necessary to use the coarsest time granularity as the uniform time granularity for that time period. However, if a network administrator wishes to view a portion of the graph at a finer resolution than the uniform granularity, the portion of the graph may be converted to use a finer time granularity than the uniform granularity as long as the minimum time granularity 32 is smaller than the uniform time granularity. A display time granularity 24 shows the time granularity used to display the graph in the display portion 40. A detailed-granularity display portion 41 of the display time granularity 24 indicates that a portion of the graph 42 is being displayed using a medium time granularity.

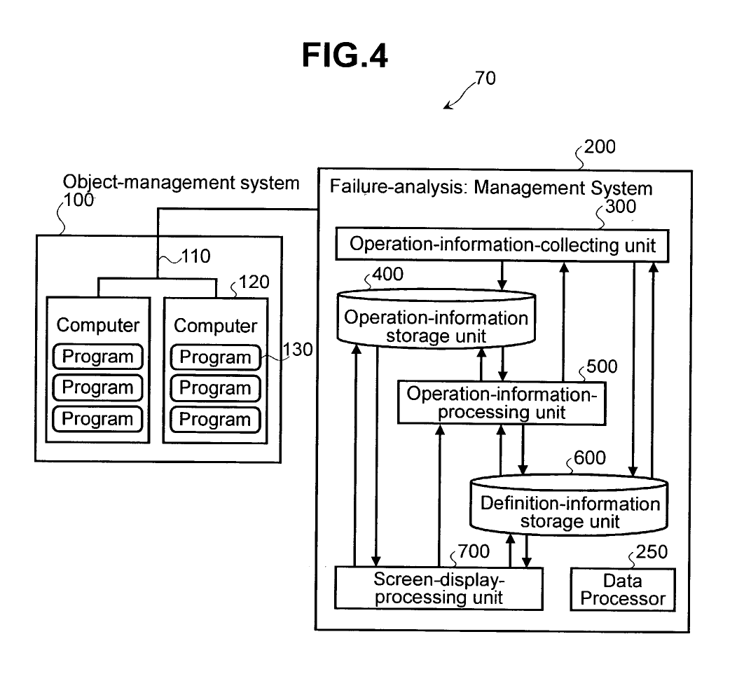

FIG. 4 shows a network system 70 for implementing the failure analysis function described above according to one embodiment of the present invention. The network system 70 is also referred to herein as a failure-analysis support system or failure-analysis system. The system 70 comprises an object-management or monitored system 100 and a failure-analysis management system 200 for collecting and storing operation information or metrics. The stored information is displayed in the display portion 10 as operating states of the system components. The monitored system 100 comprises a plurality of system components, e.g., a network 110, computers 120 and programs 130. Network components, such as a router or bridge and a program used in the network, can also be regarded as components. All system components may or may not be placed in the same network segment.

In one embodiment, the management system 200 comprises an operation-information-collecting unit 300, an operation-information-processing unit 500, an operation-information storage device or unit 400, a definition-information storage device or unit 600, and a screen-display-processing unit 700. These units may include a plurality of functional sub-units. The units 300, 500, and 700 are software programs installed in the management system 200 according to one embodiment of the present invention.

The operation-information-collecting unit collects operation information from the components in the monitored system 100. The collected operation information is provided with a timestamp to indicate the time of its retrieval and stored in the operation-information storage unit 400. The unit 300 collects operation information in accordance with an operation-information collection definition 670 stored in the definition-information storage unit 600. In one embodiment, the operation information collected is MIB. The protocol used is SNMP. The operation information is collected either periodically or in response to a request from the screen-display-processing unit 700.

The operation-information-processing unit 500 processes the MIBs collected by the unit 300. The processing unit 500 converts the MIBs to metrics and converts the time granularity of the MIBs in accordance with an operation-information-time-granularity definition and an operation-information-calculation definition stored in the definition-information storage unit 600. The operation-information-processing unit 500 stores the processed operation information or metrics in the operation-information storage unit 400. The screen-display-processing unit 700 retrieves the operation information stored in the storage unit 400 and the definition information stored in the storage unit 600 from time to time and, if necessary, processes the operation information to display the operating states of components on the display area 15.

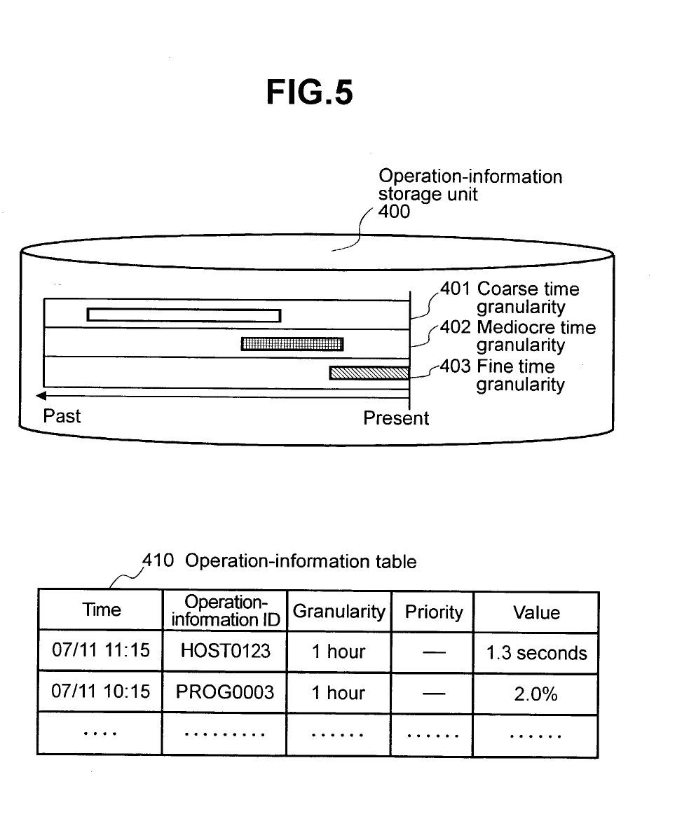

Basically, the operation-information storage unit 400 has a uniform time granularity for all pieces of operation information to be displayed along the timeline. However, the operation-information storage unit 400 may store operation information at different time granularities. FIG. 5 illustrates certain operation information stored in the storage unit 400 at non-uniform time granularities. FIG. 5 shows a coarse time granularity 401, a medium time granularity 402, and a fine time granularity 403. The fineness of the time granularity is indicated by using different colors, e.g., the darker the color, the finer the granularity.

In one embodiment, the operation information is stored at different granularities according to its relevance or importance. Generally, the relevance of information decreases over time, so recent information is stored at a finer granularity than older information. Accordingly, in one embodiment, a given operation information is initially stored at a fine granularity and is progressively converted to more coarse granularity over time, as will be explained later.

An operation-information table 410 illustrates a data format in which operation information is stored in the storage unit 400. In one embodiment, each operation information record requires at least three attributes: a timestamp, a component identification, and a value. Other information, such as priority or granularity, may be stored in an another location. If information to be displayed along a time axis is stored at non-uniform time granularities, a time granularity is assigned to each operation information record. In addition, if it is desired to keep certain operation information stored at a given time granularity, e.g., a fine time granularity, and does not wish it to be converted to a coarser granularity subsequently, a priority level is assigned to the operation information records to identify such records.

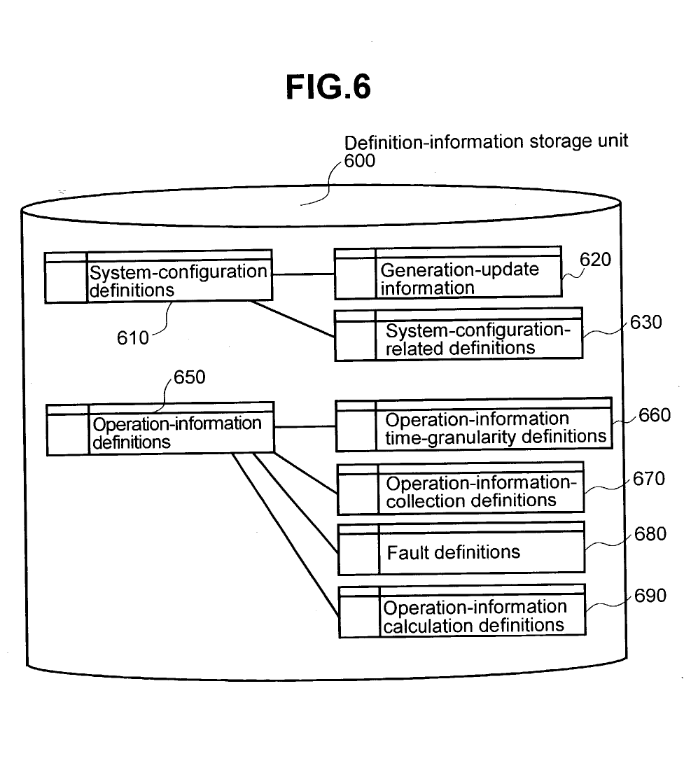

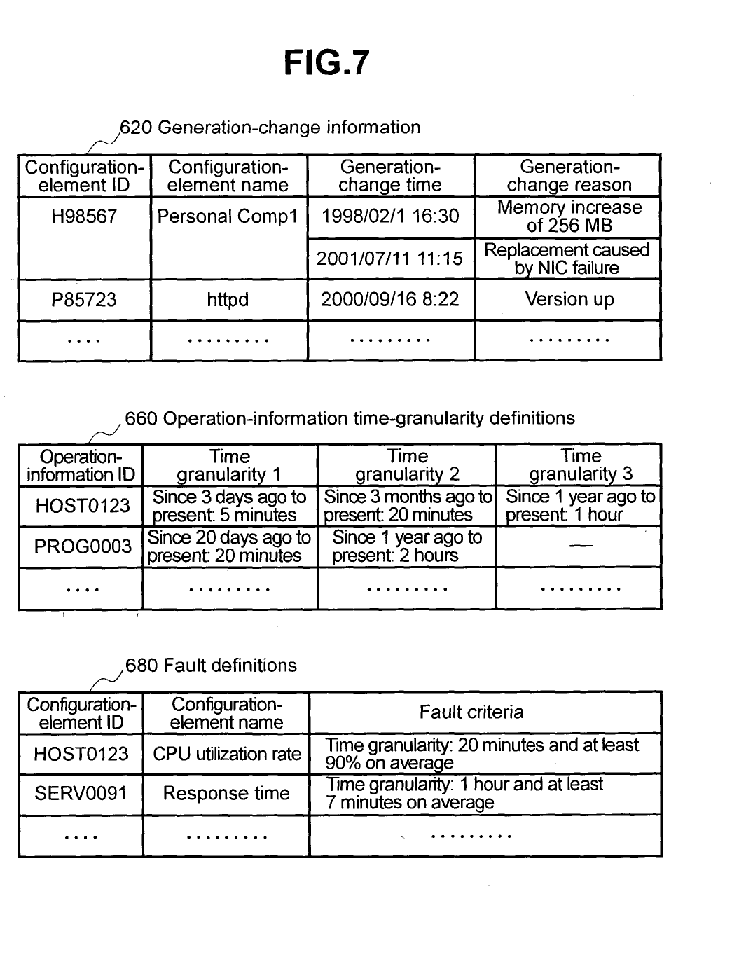

FIGS. 6 and 7 show information stored in the definition-information storage unit 600. In one embodiment, information other than the operation information is stored in the definition-information storage unit 600. Definition information includes a system-configuration definition 610 for the components 12 and an operation-information definition 650 for the operation information.

The system-configuration definition 610 includes generation-update information 620 and a system-configuration-related definition 630. As shown in FIG. 7, the generation-update information 620 provides information about the time at which an adjustment event was made to a component 12. This information is used in connection with the adjustment event bar 23 of the temporal tool 20. The system-configuration-related definition 630 defines an operational relation between two components 12 if such a relation exists.

An operation-information definition 650 includes an operation-information time-granularity definition 660, an operation-information-collection definition 670, a fault definition 680, and an operation-information calculation definition 690. The time-granularity definition 660 defines the time granularities stored in the operation-information storage unit 400. If information is stored at non-uniform time granularities, a plurality of time granularities and time ranges associated with the granularities are defined as shown in FIG. 7

The operation-information-collection definition 670 includes information the collecting unit 300 needs to retrieve the operation information, e.g., a collection time, an identify of the component from which the information is to collected, and a collection tool to be used. The fault definition 680 provides criteria for determining the operating state of a component, e.g., whether it is in normal, caution, danger, or failure state. By using the fault definition 680 and the operation-information table 410, information is generated for displaying the failure frequency 21. The operation-information calculation definition 690 includes information about converting the MIBs collected by the collecting unit 300 into the operation information to be stored in the storage unit 400. The processing unit 500 uses this definition or formula 690 to transform the MIBs to the operation information.

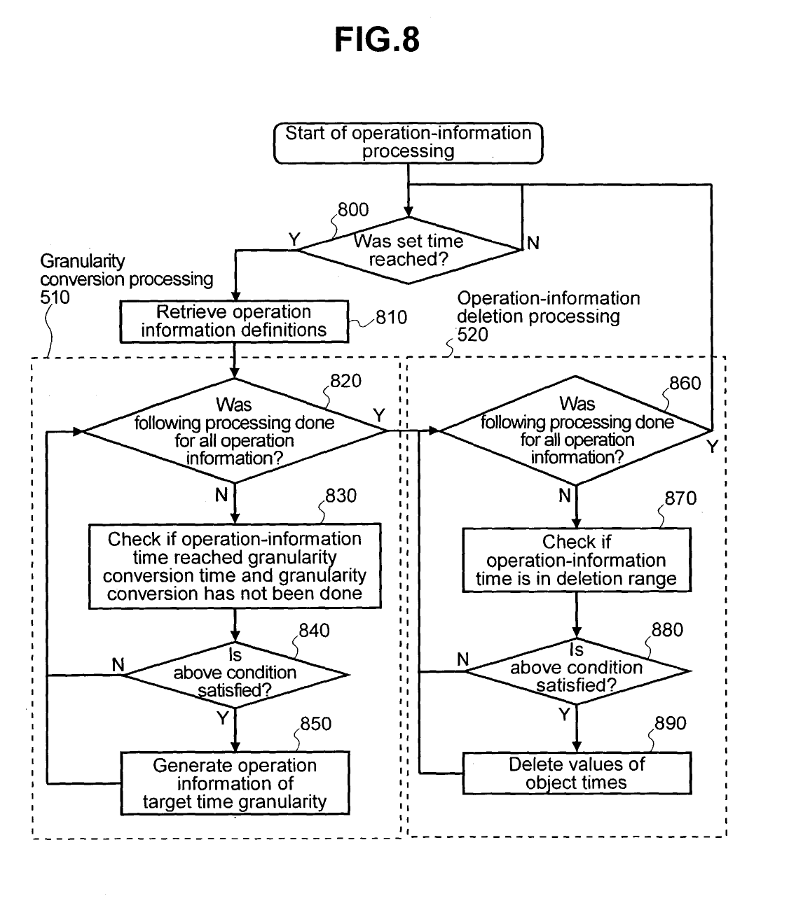

FIG. 8 is a flowchart representing processing carried out by the operation-information-processing unit 500 to store operation information at non-uniform time granularities in the operation-information storage unit 400. The flowchart begins with step 800 to determine as to whether or not a preset time has been reached. This may be done, while the operation-information-processing unit 500 is carrying out other operations. If the preset time has been reached, the flow of the processing goes on to step 810 at which the operation-information table 410 (FIG. 5) and the operation-information definition 650 (FIG. 6) are retrieved to initiate a granularity conversion processing 510. Although the granularity conversion is performed at a predetermined time interval in the present embodiment, it may be initiated by a request.

The granularity conversion processing 510 begins with step 820 to determine as to whether or not the time of operation information has attained the granularity-conversion time of the operation-information time-granularity definition 660 for all pieces of operation information. If the time of operation information has not attained the granularity-conversion time of the operation-information time-granularity definition 660, the flow of the processing goes on to step 830 to examine the number of pieces of operation information each having a time attaining the granularity-conversion time of the operation-information time-granularity definition 660. Then, the flow of the processing goes on to step 840 to form a judgment as to whether or not the number of such pieces of operation information is large enough for generating a post-conversion granularity value. If the number of such pieces of operation information is large enough for generating a post-conversion granularity value, the flow of the processing goes on to step 850 at which granularity conversion is carried out. For example, there are four consecutive pieces of operation information each having a time granularity of 5 minutes, and the post-conversion granularity value is 20 minutes. In this case, the number of pieces of operation information is large enough for generating the post-conversion granularity value. Thus, the time granularity is converted into 20 minutes. If the conversion is carried out to produce average time granularity, on the other hand, the sum of the four time granularities is divided by 4.

If the outcome of the judgment formed at step 820 indicates that the time of operation information has attained the granularity-conversion time of the operation-information time-granularity definition 660, on the other hand, the flow of the processing goes on to step 860 to form a judgment as to whether or not operation-information deletion processing 520 has been carried out for all pieces of operation information. If the operation-information deletion processing 520 has not been carried out for all the pieces of operation information, the flow of the processing goes on to step 870 to examine the value of operation information completing the granularity conversion and the value of operation information with a time exceeding a fixed time. The flow of the processing then goes on to step 880 to form a judgment as to whether or not operation information completing the granularity conversion and/or operation information with a time exceeding a fixed time exist. If such operation information exists, the flow of the processing goes on to step 890 at which such operation information is deleted periodically. This is because such operation information is regarded as information with a degraded value. Assume for example a case in which up to 100 information records can be held for each time granularity. If 120 information records are found for each time granularity for operation information in the operation-information deletion processing 520, 20 information records are deleted starting with the least recent data.

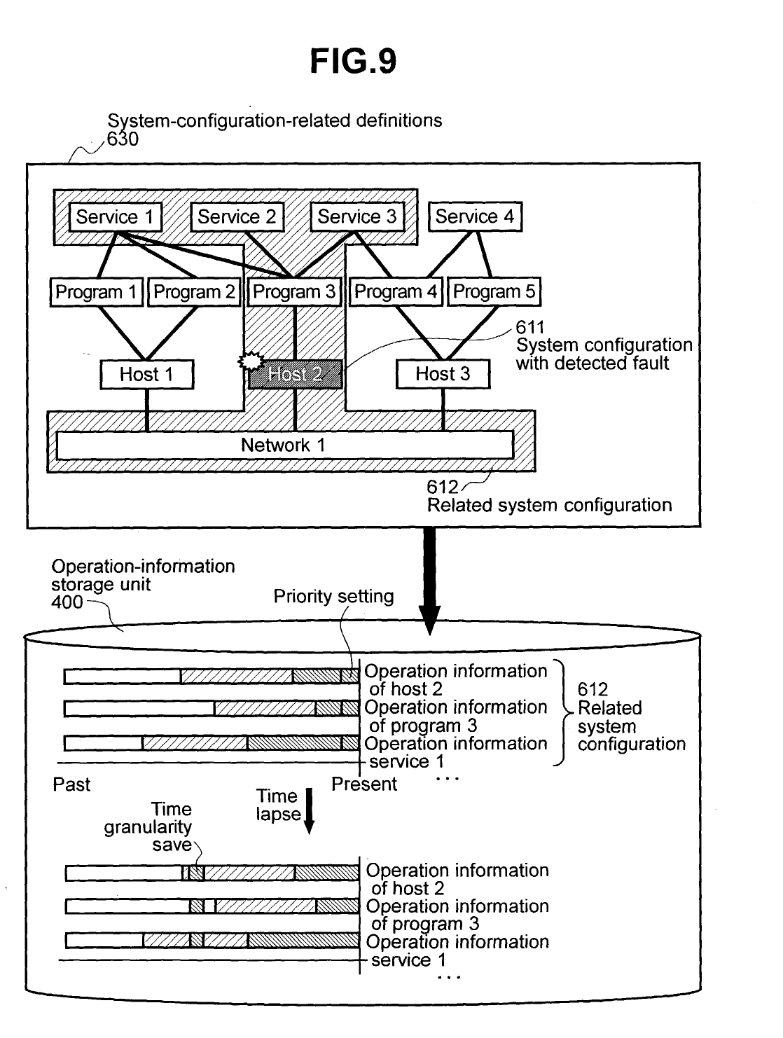

In one embodiment, when a failure occurs in the monitored system 100, operation information for only components affected by the failure is collected and stored at a fine time granularity. This operation information is given priority so that they are not converted to a coarser time granularity at a later time. Accordingly, only relevant operation is kept as a fine granularity for an extended time. FIG. 9 is a diagram showing a method of storing operation information in the event of a failure. In the present embodiment, the management system includes a definition of a relation between components, such as a system configuration relational definition 630 shown in FIG. 9. By providing such a definition, in the event of a failure, it is possible to determine the components affected by the failure and narrow the domain of possible causes of the failure. In the embodiment show in FIG. 9, when a failure occurs in a host 2 the components that may be affected by the failure are defined as services 1 to 3, program 3 and a network 1. Thus, the time granularities of their operation information are made finer. As a technique to make the time granularities finer, there are provided a method of shortening intervals at which operation information is collected.

If the storage time granularity is changed in accordance with the freshness of the operation information, as is the case with the operation-information storage unit 400 shown in FIG. 5, as time progresses, the operation-information-processing unit 500 makes the time granularity coarser. A priority level is specified in an operation-information table 410 in the event of the failure so as to prevent the time granularity from becoming coarser.

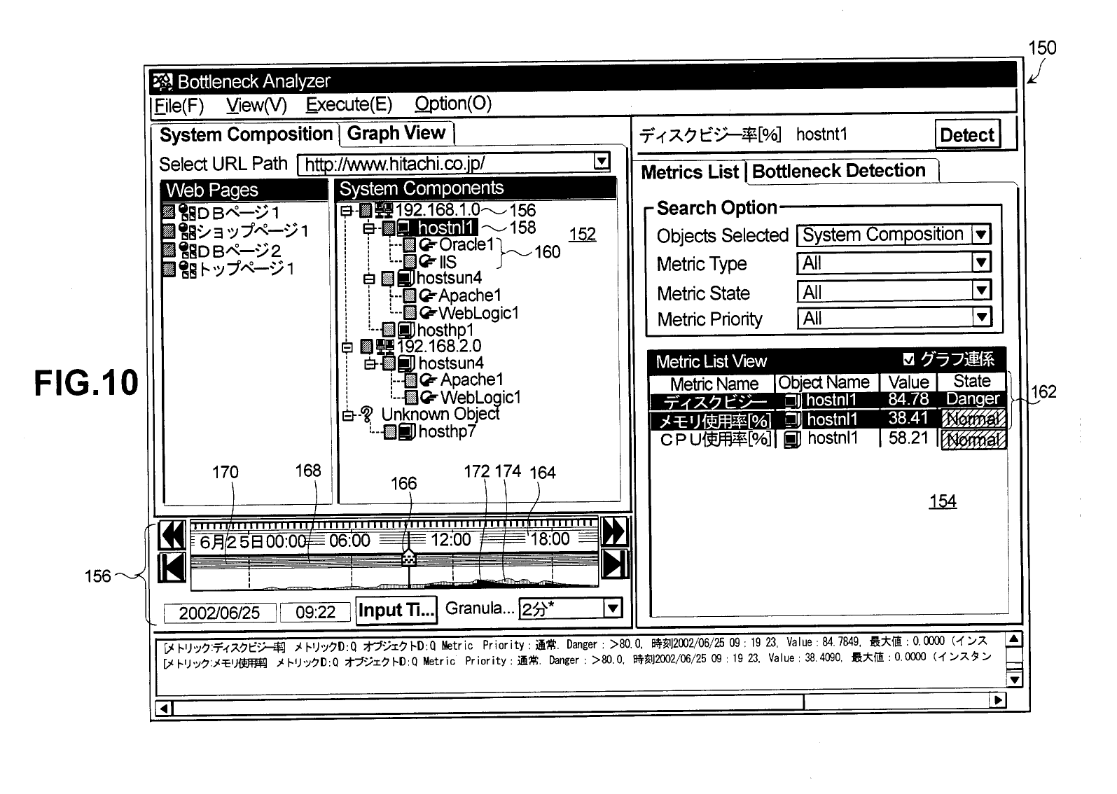

Referring to FIG. 10, a display area 150 of a network management system includes an operating state display portion 152, a metric list view 154, and a temporal tool 156 according to one embodiment of the present invention. The display portion 152 corresponds to the display portion 10 of FIG. 1, and displays the system components and their operating states.

The system or primary components displayed include a network 156, a server 158, and applications 160 running within the server. A color-coded icon provided next to each component indicates the operating state of the corresponding component. In one embodiment, a red icon indicates a failure or dangerous operating state, an orange or yellow indicates a caution state, and a blue indicates a normal state.

The metrics list view 154 displays one or more secondary components associated with a primary component that has been selected by a network administrator for more detailed viewing. For example, in FIG. 10, the “hostnt 1” server 158 is selected by a network administrator for more detailed viewing. A plurality of secondary components 162 is displayed on the metric list view 154 including their operating state information. One or more of these secondary components may be selected for even more detailed viewing, such as in the graphs 42 of FIG. 3.

The temporal tool 156 includes a timeline bar 164 and a time selector 166. The selector 166 may be moved along the timeline to view the operating states of the components corresponding to the selected time, as explained previously. The tool 156 also includes a fault frequency bar 170. A dark color portion 172 indicates a number of component failures experienced at that point of time, and a light color portion 174 indicates a number of component cautions experienced at that point of time.

The above embodiments are described to illustrate the present invention and should not be used to limit the scope of the present invention. As will be understood by a person skilled in the art, many variation or modifications of the illustrated embodiments are possible. For example, the present invention may be implemented by using a software program preinstalled in a management system or a program stored in a computer readable medium that is installed in a management system subsequently. The storage network in FIG. 1B may be a network area storage rather than a storage area network. Accordingly, the scope of the present invention should be interpreted by using the appended claims.

What is claimed is:

1. A network management system for managing a network system, comprising:
a first data storage device configured to store operation information of a plurality of components of the network system, the operation information providing information about operating states of the components;
a display device configured to provide a temporal tool displaying a plurality of points of time and a component display area to display a plurality of first indications representing the components and a plurality of second indications representing operating states of the components, wherein the plurality of the first and second indications correspond to one of the points of time selected on the temporal tool; and
a data processor configured to process the operation information and transmit data to the display device to display the first and second indications on the display area of the display device.

2. The system of claim 1, further comprising:
a second data storage device including computer readable code to enable the data processor to process the operation information, the second data storage device including:
code for providing the temporal tool on display device,
code for providing the display area on the display device, and
code for retrieving operation information corresponding to the selected point of time from the first data storage device for displaying the first and second indications on the display device.

3. The system of claim 2, wherein each one of the first indications is associated with each one of the second indications, the first indications being symbols representing the components, and the second indications being symbols representing operating states of the corresponding components.

4. The system of claim 3, wherein the second indications are color-coded to indicate the operating states of the components, wherein a first color indicates a normal operating state and a second color indicates a non-normal operating state.

5. The system of claim 4, wherein the display device displays a sub-component display portion displaying a plurality of sub-components of one of the components being displayed on the component display area.

6. The system of claim 3, wherein the temporal tool includes a timeline bar and the system is configured to display on the display area operating states of the components corresponding to a time selected on the timeline bar, so that the operating states of the components may be displayed on the display area seamlessly according to selections made on the timeline bar.

7. The system of claim 2, wherein the first and second storage devices are different devices.

8. The system of claim 1, wherein the system is configured to store in the first storage device first operation information of the components at a first time granularity and then convert the first operation information to second operation information stored at a second time granularity at a later time, wherein the first operation information provides coarser information than the first operation information.

9. The system of claim 8, wherein the system is configured to convert the second operation information to third operation information stored at a third time granularity a given time after the conversion of the first operation information to the second operation information, the third operation information providing coarser information than the second operation information.

10. The system of claim 8, wherein the system is configured to associate priority information to selected first operation information to prevent it from being converted to the second operation information.

11. The system of claim 10, wherein the selected first operation information provides information about a non-normal operating state of one of the components.

12. A method of managing a network system including a plurality of components, the method comprising:
providing a temporal tool on a display device, the tool including a plurality of points of time; and
displaying information about first operating states of the components on the display device in response to a first point of time selected on the temporal tool, the first operating states representing operating states of the components at the first point of time.

13. The method of claim 12, wherein the temporal tool includes a timeline bar whereon the plurality of points of time are provided along a given axis, wherein each point of time represents a predetermined time interval.

14. The method of claim 12, further comprising:
displaying information about second operating states of the components on the display device in response to a second point of time selected on the temporal tool, the second operating states representing operating states of the components at the second point of time, thereby providing seamless display of operating states of the components over an extended time period.

15. The method of claim 12, further comprising:
storing first operation information providing information about operating states of the plurality of components in a storage device, the first operation information being stored at a first time granularity; and
converting the first operation information to second operation information of a second time granularity at a subsequent conversion time after the storing step, the second operation information providing more coarse information than the first operation information.

16. The method of claim 15, further comprising:
transforming the second operation information to third operation information of a third time granularity at a later time after the converting step, the third operation information providing more coarse information than the second operation information.

17. The method of claim 15, further comprising:
associating priority information to selected first operation information to prevent its conversion to the second operation information.

18. The method of claim 17, wherein the selected first operation information provides information about an irregular operating state of one of the components.

19. The method of claim 18, further comprising:
identifying components that are affected by the component experiencing the irregular operating state; and
associating priority information to the first operation information of the identified components to prevent their first operation information from being converted to second operation information at the conversion time.

20. The method of claim 12, wherein the network system is a storage area network system or a messaging network system.

21. A method of managing a storage area network (SAN) system, comprising:
storing in a storage device first operation information providing information about operating states of a plurality of components of the SAN system, the first operation information being stored at a first time granularity;
providing a timeline tool on a display device, the tool including a plurality of points of time, each point of time representing a time interval;
displaying information about first operating states of the components on the display device in response to selection of a first point of time on the tool, the first operating states representing operating states of the components at the first point of time;
displaying information about second operating states of the components on the display device in response to selection of a second point of time on the tool, the second operating states representing operating states of the components at the second point of time, thereby providing seamless display of operating states of the components over the plurality of the points of time; and
converting the first operation information to second operation information of a second time granularity at a later time after the storing step, the second operation information providing more coarse information than the first operation information.

22. A method of managing a messaging network system, comprising:
storing in a storage device first operation information providing information about operating states of a plurality of components of the network system, the first operation information being stored at a first time granularity;
providing a timeline tool on a display device, the tool including a plurality of points of time, each point of time representing a time;
displaying information about first operating states of the components on the display device in response to selection of a first point of time on the tool, the first operating states representing operating states of the components at the first point of time;
displaying information about second operating states of the components on the display device in response to selection of a second point of time on the tool, the second operating states representing operating states of the components at the second point of time, thereby providing seamless display of operating states of the components over the plurality of the points of time;
converting the first operation information to second operation information of a second time granularity at a later time after the storing step, the second operation information providing more coarse information than the first operation information; and
associating priority information to selected first operation information to prevent its conversion to the second operation information, wherein the selected first operation information provides information about an irregular operating state of one of the components.

23. The method of claim 22, further comprising:
providing an adjustment event bar on the display device, the adjustment event bar providing information about occurrence of an event that may affect the operating state of one of the components.

24. A computer readable medium including a software program for managing a network system, the medium comprising:
code for providing a temporal tool on a display device, the tool including a plurality of points of time; and
code for displaying information about first operating states of the components on the display device in response to a first point of time selected on the temporal tool, the first operating states representing operating states of the components at the first point of time.
